(19) United States
(12) Patent Application Publication
(10) Pub. No.: US 2025/0008459 A1
(43) Pub. Date: Jan. 2, 2025

(54) S-SSB STRUCTURE FOR LARGER SUBCARRIER SPACING

(71) Applicant: Samsung Electronics Co., Ltd., Suwon-si (KR)

(72) Inventors: Hongbo Si, Allen, TX (US); Emad Nader Farag, Flanders, NJ (US); Carmela Cozzo, San Diego, CA (US); Kyeongin Jeong, Allen, TX (US); Shiyang Leng, Allen, TX (US); Anil Agiwal, Allen, TX (US)

(21) Appl. No.: 18/741,483

(22) Filed: Jun. 12, 2024

Related U.S. Application Data
(60) Provisional application No. 63/523,827, filed on Jun. 28, 2023.

(51) Int. Cl. H04W 56/00; H04L 27/26; H04W 92/18

(52) U.S. Cl. CPC H04W 56/0015; H04L 27/26025; H04W 92/18

(57) ABSTRACT

Apparatuses and methods for a sidelink synchronization signal block (S-SSB) structure for larger subcarrier spacing. A method performed by a user equipment (UE) in a wireless communication system includes determining a number M of consecutive orthogonal frequency division multiplexing (OFDM) symbols for a sidelink synchronization signals and physical sidelink broadcast channel (S-SS/PSBCH) block and determining a slot group of S consecutive slots including a number N_{SSB} of S-SS/PSBCH blocks. The method further includes determining a time domain pattern for a number N_{period}^{S-SSB} of S-SS/PSBCH blocks within a period and receiving the S-SS/PSBCH block based on the time domain pattern.

### CROSS-REFERENCE TO RELATED AND CLAIM OF PRIORITY

The present application claims priority under 35 U.S.C. § 119 (e) to U.S. Provisional Patent Application No. 63/523,827 filed on Jun. 28, 2023, which is hereby incorporated by reference in its entirety.

### TECHNICAL FIELD

The present disclosure relates generally to wireless communication systems and, more specifically, the present disclosure is related to apparatuses and methods for a sidelink synchronization signals and physical sidelink broadcast channel block (S-SS/PSBCH block or S-SSB) structure for larger subcarrier spacing.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to a S-SSB structure for larger subcarrier spacing.

In one embodiment, a user equipment (UE) in a wireless communication system. The UE includes a processor configured to determine a number M of consecutive orthogonal frequency division multiplexing (OFDM) symbols for a S-SS/PSBCH block, determine a slot group of S consecutive slots including a number N_{SSB} of S-SS/PSBCH blocks, and determine a time domain pattern for a number N_{period}^{S-SSB} of S-SS/PSBCH blocks within a period. The UE further includes a transceiver operably coupled to the processor. The transceiver is configured to receive the S-SS/PSBCH block based on the time domain pattern.

In another embodiment, a method performed by a UE in a wireless communication system is provided. The method includes determining a number M of consecutive OFDM symbols for a S-SS/PSBCH block and determining a slot group of S consecutive slots including a number N_{SSB} of S-SS/PSBCH blocks. The method further includes determining a time domain pattern for a number N_{period}^{S-SSB} of S-SS/PSBCH blocks within a period and receiving the S-SS/PSBCH block based on the time domain pattern.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of an example resource pool according to embodiments of the present disclosure;

FIG. 7 illustrates diagrams of example slot structures according to embodiments of the present disclosure;

FIG. 8 illustrates diagrams of example S-SS/PSBCH blocks according to embodiments of the present disclosure;

FIG. 9 illustrates a diagram of example S-SSB structures according to embodiments of the present disclosure;

FIG. 10 illustrates a diagram of example S-SSB mapping according to embodiments of the present disclosure;

FIG. 11 illustrates a diagram of example S-SSB mapping according to embodiments of the present disclosure; and

FIG. 12 illustrates a flowchart of an example UE procedure for determining the sidelink resource pool according to embodiments of the present disclosure.

### DETAILED DESCRIPTION

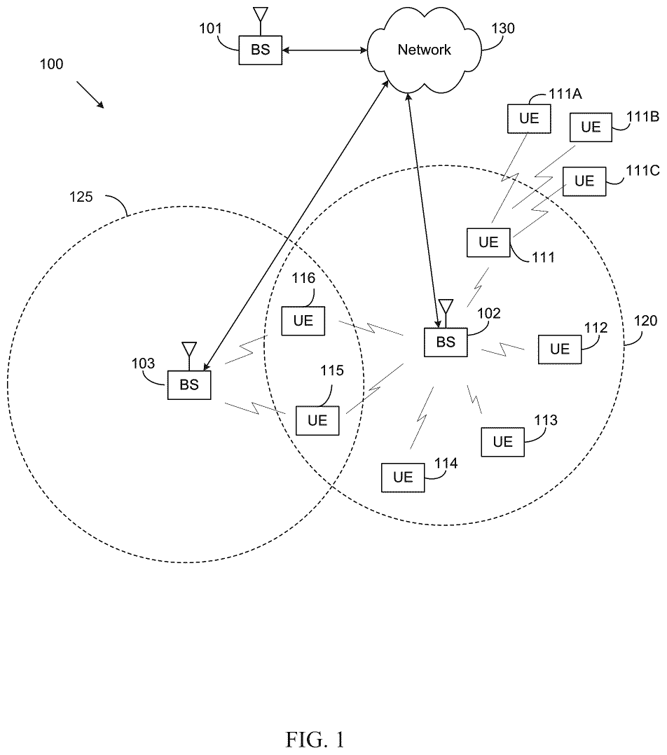

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v16.6.0, “NR; Physical channels and modulation;” [2] 3GPP TS 38.212 v16.6.0, “NR; Multiplexing and channel coding;” [3] 3GPP TS 38.213 v16.6.0, “NR; Physical layer procedures for control;” [4] 3GPP TS 38.214 v16.6.0, “NR; Physical layer procedures for data;” and [5] 3GPP TS 38.331 v16.5.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as SL at the physical layer) for communication and/or positioning.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a S-SSB structure for larger subcarrier spacing. In certain embodiments, and one or more of the gNBs 101-103 includes circuitry, programing, or a combination thereof, for supporting a S-SSB structure for larger subcarrier spacing.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

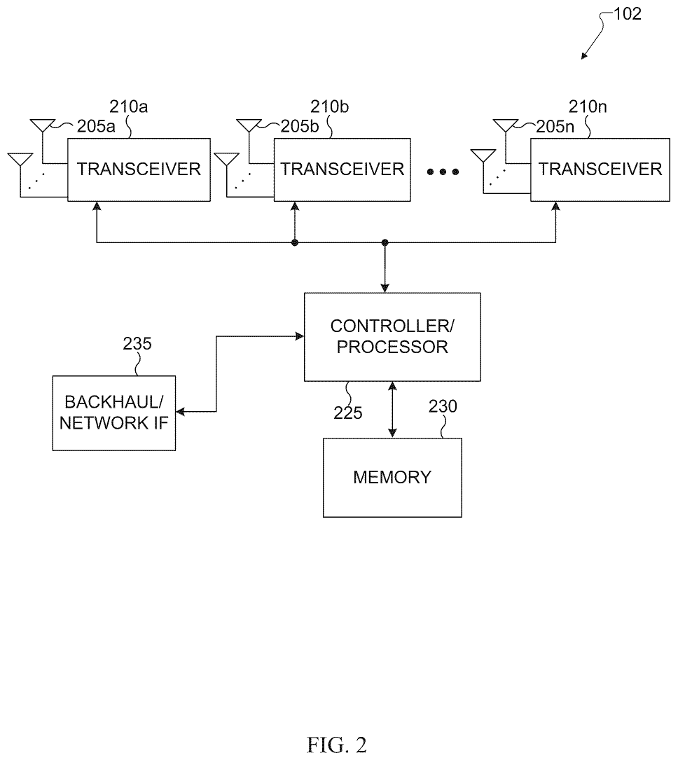

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a S-SSB structure for larger subcarrier spacing. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

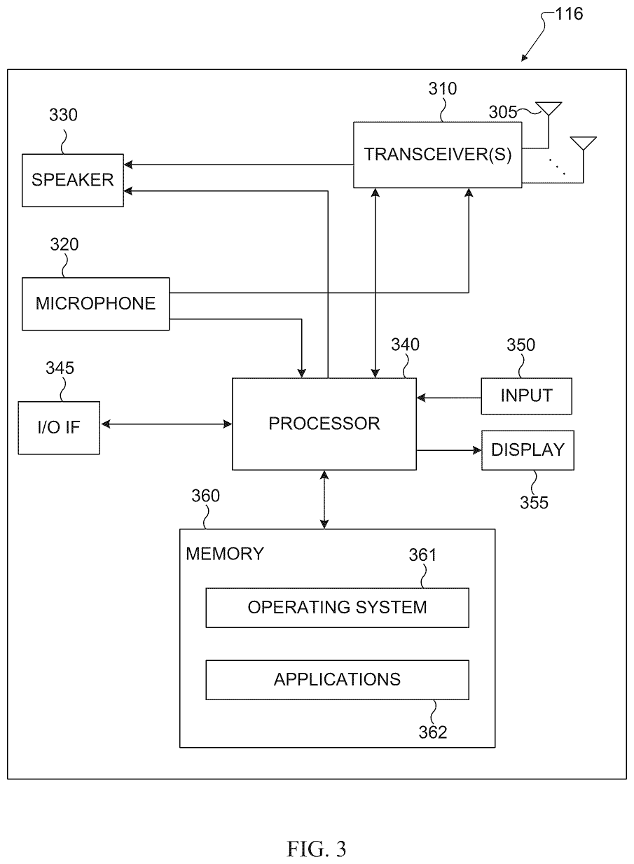

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a sidelink (SL) channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals and SL channels and/or signals and the transmission of UL channels and/or signals and SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a S-SSB structure for larger subcarrier spacing.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

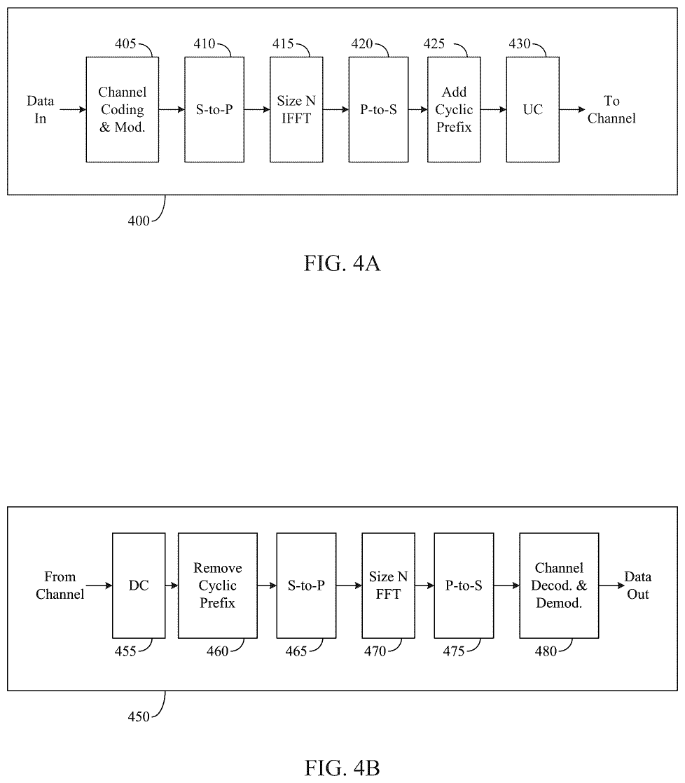

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In various embodiments, the transmit path 400 may be described as being implemented in a first UE (such as a UE 111) and the receive path 450 may be described as being implemented in a second UE (such as a UE 111A) for communication over a SL or vice versa. It will be understood that the receive path 450 can be implemented in a first UE and that the transmit path 400 can be implemented in a second UE. In some embodiments, the transmit path 400 and/or the receive path 450 is configured to identify and/or utilize a S-SSB structure for larger subcarrier spacing as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or for transmitting in the SL to another UE and may implement a receive path 450 for receiving in the downlink from gNBs 101-103 or for receiving in the SL from another UE.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

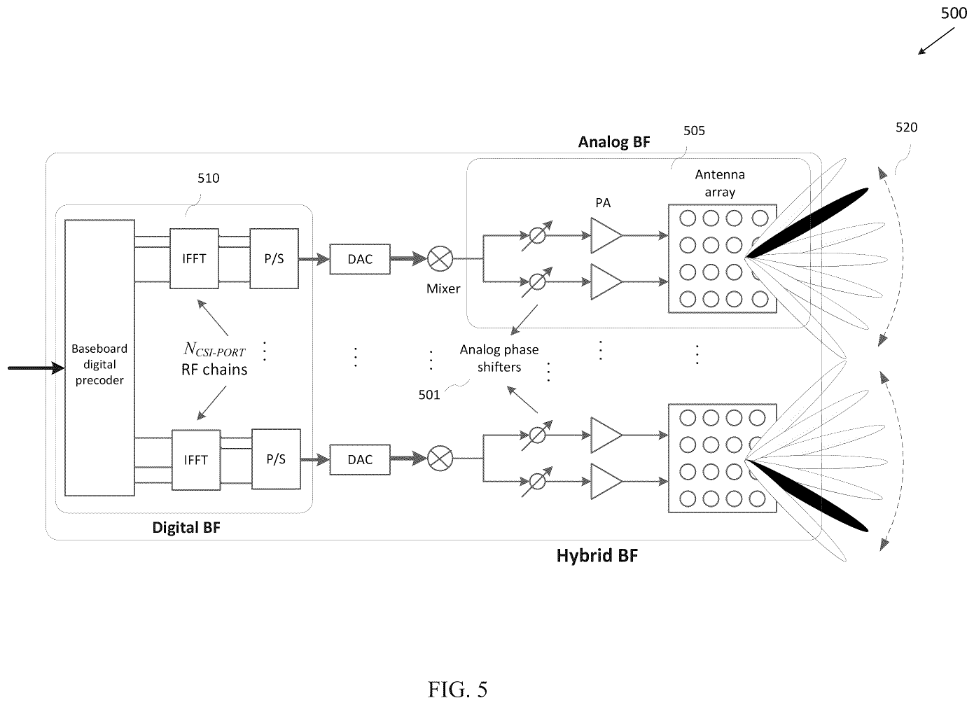

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NGSI-PORT. A digital beamforming unit 510 performs a linear combination across NOSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

A description of example embodiments is provided on the following pages.

Any of the variation embodiments can be utilized independently or in combination with at least one other variation embodiment.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This present disclosure covers several components which can be used in conjunction or in combination with one another, or can operate as standalone schemes.

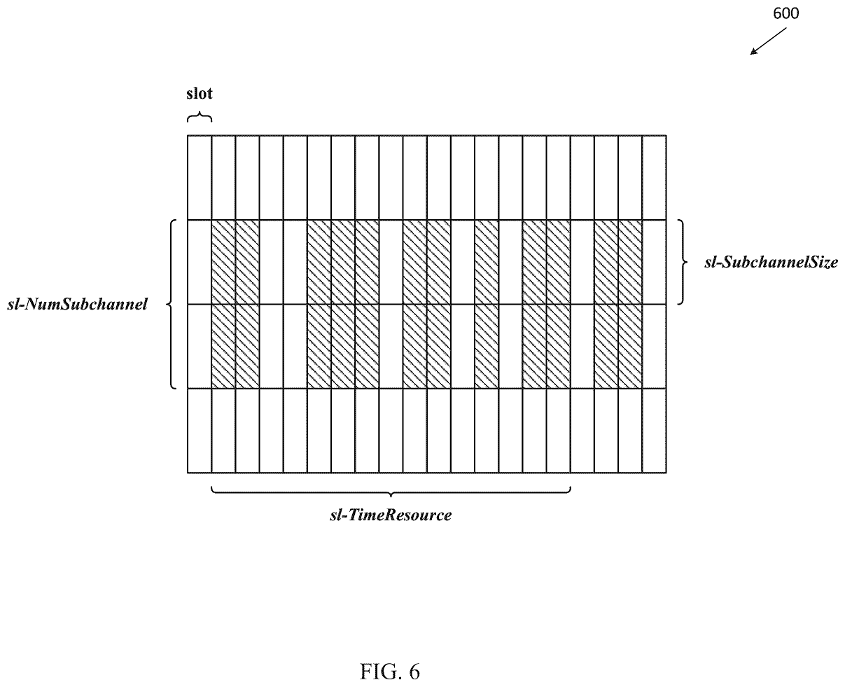

FIG. 6 illustrates a diagram of an example resource pool 600 according to embodiments of the present disclosure. For example, resource pool 600 can be accessed by any of the UEs 111-116 of FIG. 1. This example is for illustration only and other embodiments can be used without departing from the scope of the present disclosure.

In Rel-16 NR vehicle-to-everything (V2X), transmission and reception of SL signals and channels are based on resource pool(s) confined in the configured SL bandwidth part (BWP). In the frequency domain, a resource pool includes a (pre-)configured number (e.g., sl-NumSubchannel) of contiguous sub-channels, wherein each sub-channel includes a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). With reference to FIG. 6, an illustration of a resource pool is shown.

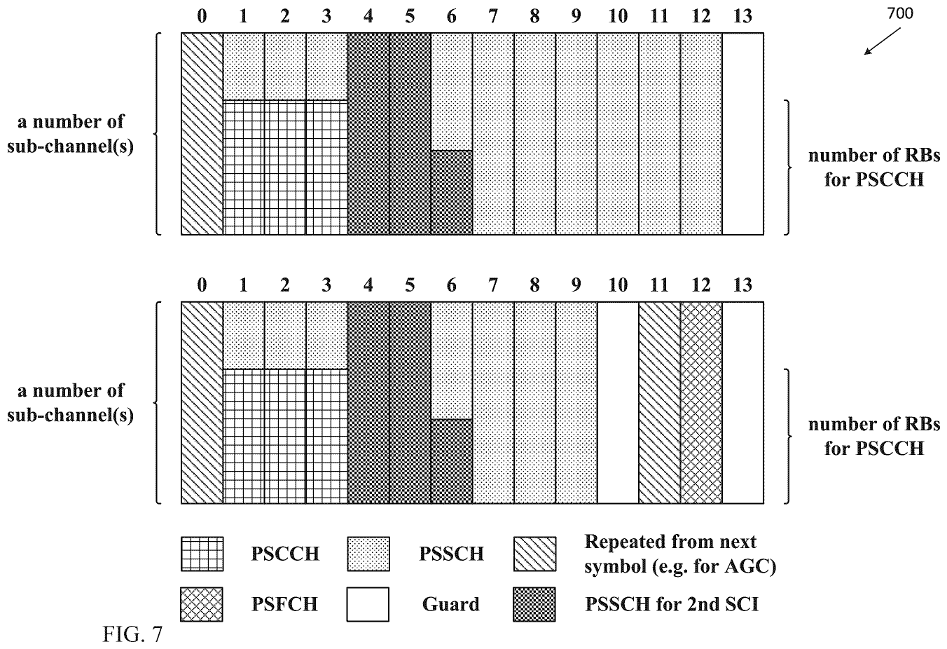

FIG. 7 illustrates diagrams of example slot structures 700 according to embodiments of the present disclosure. For example, slot structures 700 can be utilized by the UE 111C of FIG. 1. This example is for illustration only and other embodiments can be used without departing from the scope of the present disclosure.

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE shall transmit the PSSCH in consecutive symbols within a slot of the resource pool and PSSCH resource allocation starts from the second symbol configured for sidelink, e.g., startSLsymbol+1. The first symbol configured for sidelink is duplicated from the second configured for sidelink, for automatic gain control (AGC) purpose. The UE (e.g., the UE 111) shall not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated sidelink control information (SCI).

For transmitting a PSCCH, the UE can be provided a number of symbols (either 2 symbols or 3 symbols) in a resource pool (e.g., sl-TimeResourcePSCCH) starting from the second symbol configured for sidelink, e.g. startSLsymbol+1; and further provided a number of RBs in the resource pool (e.g. sl-FreqResourcePSCCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In frequency domain, PSFCH is transmitted in a single RB, wherein orthogonal covering coding (OCC) can be applied within the RB for multiplexing, the location of the RB is determined based on an indication of a bitmap (e.g., sl-PSFCH-RB-Set), and the selection of PSFCH resource is according to the source ID and destination ID.

The first symbol including PSSCH and PSCCH is duplicated for AGC purpose. With reference to FIG. 7, the slot structure including PSSCH, PSCCH and PSFCH is shown.

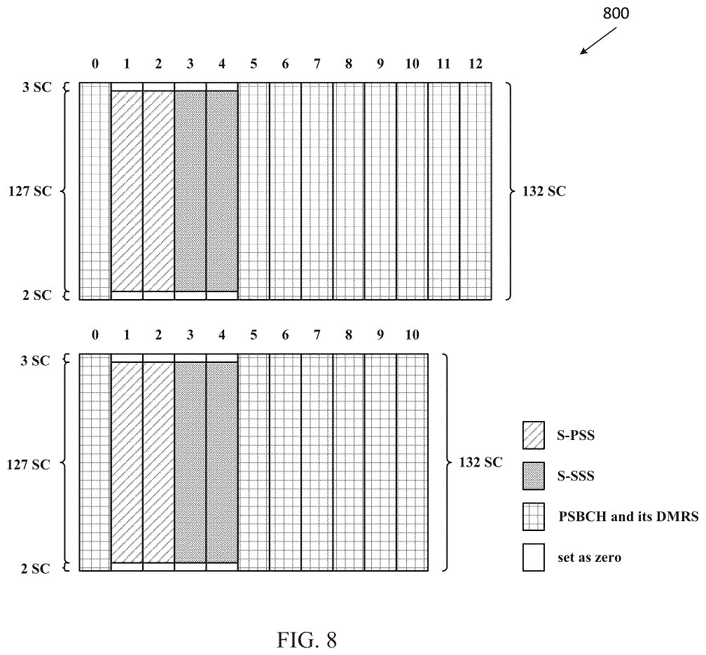

FIG. 8 illustrates diagrams of example S-SS/PSBCH blocks 800 according to embodiments of the present disclosure. For example, S-SS/PSBCH blocks 800 may be utilized by any of the UEs 111A-111C. This example is for illustration only and other embodiments can be used without departing from the scope of the present disclosure.

In NR sidelink, sidelink synchronization signals and physical sidelink broadcast channel block (S-SS/PSBCH block or S-SSB) is supported. As shown in FIG. 8, one S-SS/PSBCH block includes 132 contiguous subcarriers (SC) in frequency domain and 14 contiguous symbols for normal cyclic prefix (CP) or 12 contiguous symbols for extended CP in time domain. Within a S-SS/PSBCH block, sidelink primary synchronization signal (S-PSS) is mapped to symbol #1 and #2, and sidelink secondary synchronization signal (S-SSS) is mapped to symbol #3 and #4, wherein subcarriers with index 2 to 128 (127 subcarriers in total) are mapped for S-PSS or S-SSS in frequency domain, while subcarriers with indexes 0, 1, 129, 130, and 131 are set as zero. PSBCH is mapped to symbol #0 and #5 to #N_{symb}^{S-SSB}−1, with demodulation reference signal (DM-RS) for PSBCH multiplexed in the symbols, wherein N_{symb}^{S-SSB}=13 for normal CP and NN_{symb}^{S-SSB}=11 for extended CP. A summary of the mapping in time and frequency domain is shown in Table 1.

TABLE 1
Resource mapping within a S-SS/PSBCH block.

| Signal or channel | Symbol index | Subcarrier index |
|---|---|---|
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , | 0, 1, . . . , 130, 131 |
| | N_{symb}^{S-SSB} − 1 | |
| DM-RS for PSBCH | 0, 5, 6, . . . , | 0, 4, . . . , 124, 128 |
| | N_{symb}^{S-SSB} − 1 | |

Embodiments of the present disclosure recognize that, for sidelink operating on a higher frequency range (e.g., FR2-2 with 52.6 to 71 GHz), there is a need to support a large subcarrier spacing for SL transmissions, e.g., S-SSB transmission, such as at least one from 120 kHz, 240 kHz, 480 kHz, or 960 kHz. For this case, the S-SSB structure needs to be enhanced.

The embodiments and examples in this disclosure can be applied to small subcarrier spacing (e.g., 15 kHz, 30 kHz, 60 kHz) as well, although motivated by large subcarrier spacing.

This present disclosure includes embodiments for supporting sidelink synchronization signals and physical sidelink broadcast channel for large subcarrier spacing. More precisely, the following components are provided in this disclosure:
S-SSB structure for large subcarrier spacing (SCS)
S-SSB mapping into slots
S-SSB time domain pattern
Impact to resource pool
Example UE procedure

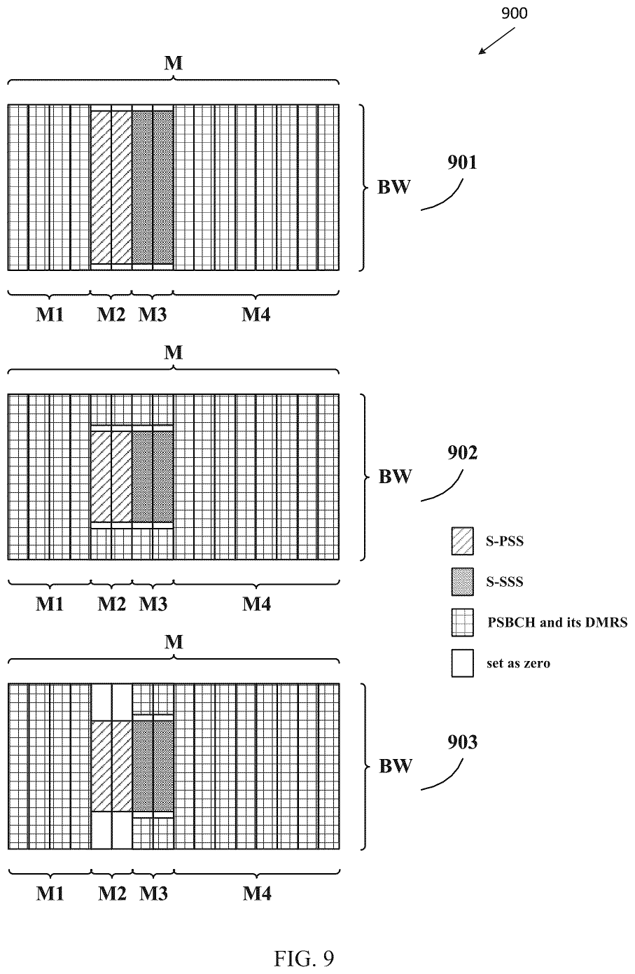

FIG. 9 illustrates a diagram of example S-SSB structures 900 according to embodiments of the present disclosure. For example, S-SSB structures 900 may be utilized by the UE 111A of FIG. 1. This example is for illustration only and other embodiments can be used without departing from the scope of the present disclosure.

In one embodiment, with reference to FIG. 9, a sidelink synchronization signals and physical sidelink broadcast channel block (S-SSB) can include a number M of consecutive OFDM symbols in the time domain and a number BW of consecutive RBs in the frequency domain. This embodiment can be applicable to at least one of 120 kHz, 240 kHz, 480 kHz, or 960 kHz.

In one example, with reference to FIG. 9, the S-SSB 901 includes a number M1 of OFDM symbols for PSBCH at the beginning of the M OFDM symbols (e.g., can be used for AGC purpose), a number M2 of OFDM symbols for S-PSS immediately after the M1 OFDM symbols for PSBCH, a number M3 of OFDM symbols for S-SSS immediately after the M2 OFDM symbols for S-PSS, and a number M4 of OFDM symbols for PSBCH immediately after the M3 OFDM symbols for S-SSS.

In another example, with reference to FIG. 9, the S-SSB 902 includes a number M1 of OFDM symbols for PSBCH at the beginning of the M OFDM symbols (e.g., can be used for AGC purpose), a number M2 of OFDM symbols for S-PSS and PSBCH multiplexed in the frequency domain immediately after the M1 OFDM symbols for PSBCH, a number M3 of OFDM symbols for S-SSS and PSBCH multiplexed in the frequency domain immediately after the M2 OFDM symbols for S-PSS and PSBCH multiplexed in the frequency domain, and a number M4 of OFDM symbols for PSBCH immediately after the M3 OFDM symbols for S-SSS and PSBCH multiplexed in the frequency domain.

In yet another example, with reference to FIG. 9, the S-SSB 903 includes a number M1 of OFDM symbols for PSBCH at the beginning of the M OFDM symbols (e.g., can be used for AGC purpose), a number M2 of OFDM symbols for S-PSS immediately after the M1 OFDM symbols for PSBCH, a number M3 of OFDM symbols for S-SSS and PSBCH multiplexed in the frequency domain immediately after the M2 OFDM symbols for S-PSS, and a number M4 of OFDM symbols for PSBCH immediately after the M3 OFDM symbols for S-SSS and PSBCH multiplexed in the frequency domain.

For one instance of the examples in this embodiment, M1 can be fixed. For one sub-instance, M1=1. For another sub-instance, M1=2. For yet another sub-instance, M1=4. For yet another sub-instance, M1=7.

For another instance of this examples in this embodiment, M1 can be fixed/pre-determined per the SCS of the S-SSB. For one sub-instance, M1=1 for 120 kHz SCS. For another sub-instance, M1=2 for 240 kHz SCS. For yet another sub-instance, M1=4 for 480 kHz SCS. For yet another sub-instance, M1=7 or M1=8 for 960 kHz SCS.

For yet another instance of this examples in this embodiment, M1 can be determined based on the SCS of the S-SSB, e.g., in the form of M1=R*M1′, wherein R=SCS_SSB/SCS_ref, and SCS_SSB is the SCS of the S-SSB, and SCS_ref is the reference SCS. For one sub-instance, SCS_ref=120 kHz. For another sub-instance, M1′ can be fixed as 1. For yet another sub-instance, M1′ can be (pre-)configured.

For yet another instance of this examples in this embodiment, M1 can be (pre-) configured.

For one instance of the examples in this embodiment, M2 can be fixed. For one sub-instance, M2=2. For another sub-instance, M2=4. For yet another sub-instance, M2=8. For yet another sub-instance, M2=16.

For another instance of this examples in this embodiment, M2 can be fixed/pre-determined per the SCS of the S-SSB. For one sub-instance, M2=2 for 120 kHz SCS. For another sub-instance, M2=4 for 240 kHz SCS. For yet another sub-instance, M2=8 for 480 kHz SCS. For yet another sub-instance, M2=16 for 960 kHz SCS.

For yet another instance of this examples in this embodiment, M2 can be determined based on the SCS of the S-SSB, e.g., in the form of M2=R*M2′, wherein R=SCS_SSB/SCS_ref, and SCS_SSB is the SCS of the S-SSB, and SCS_ref is the reference SCS. For one sub-instance, SCS_ref=120 kHz. For another sub-instance, M2′ can be fixed as 2. For yet another sub-instance, M2′ can be (pre-)configured.

For yet another instance of this examples in this embodiment, M2 can be (pre-)configured.

For one instance of the examples in this embodiment, M3 can be fixed. For one sub-instance, M3=2. For another sub-instance, M3=4. For yet another sub-instance, M3=8. For yet another sub-instance, M3=16.

For another instance of this examples in this embodiment, M3 can be fixed/pre-determined per the SCS of the S-SSB. For one sub-instance, M3=2 for 120 kHz SCS. For another sub-instance, M3=4 for 240 kHz SCS. For yet another sub-instance, M3=8 for 480 kHz SCS. For yet another sub-instance, M3=16 for 960 kHz SCS.

For yet another instance of this examples in this embodiment, M3 can be determined based on the SCS of the S-SSB, e.g., in the form of M3=R*M3′, wherein R=SCS_SSB/SCS_ref, and SCS_SSB is the SCS of the S-SSB, and SCS_ref is the reference SCS. For one sub-instance, SCS_ref=120 kHz. For another sub-instance, M3′ can be fixed as 2. For yet another sub-instance, M3′ can be (pre-)configured.

For yet another instance of this examples in this embodiment, M3 can be (pre-) configured.

For one instance of the examples in this embodiment, M4 can be fixed. For one sub-instance, M4=8.

For another instance of this examples in this embodiment, M4 can be fixed/pre-determined per the SCS of the S-SSB. For one sub-instance, M4=8 for 120 kHz SCS. For another sub-instance, M4=7 for 240 kHz SCS. For yet another sub-instance, M4=5 for 480 kHz SCS. For yet another sub-instance, M4=2 for 960 kHz SCS.

For yet another instance of this examples in this embodiment, M4 can be determined based on the SCS of the S-SSB, e.g., in the form of M4=R*M4′, wherein R=SCS_SSB/SCS_ref, and SCS_SSB is the SCS of the S-SSB, and SCS_ref is the reference SCS. For one sub-instance, SCS_ref=120 kHz. For another sub-instance, M4′ can be fixed as 8. For yet another sub-instance, M4′ can be (pre-)configured.

For yet another instance of this examples in this embodiment, M4 can be determined based on M4=M-M1-M2-M3, wherein M, M1, M2, and M3 are based on examples of this disclosure.

For yet another instance of this examples in this embodiment, M4 can be (pre-)configured.

For one instance of the examples in this embodiment, M can be fixed. For one sub-instance, M=13. For another sub-instance, M=14.

For another instance of this examples in this embodiment, M can be fixed/pre-determined per the SCS of the S-SSB. For one sub-instance, M=13 for 120 kHz SCS. For another sub-instance, M=26 for 240 kHz SCS. For yet another sub-instance, M=52 for 480 kHz SCS. For yet another sub-instance, M=104 for 960 kHz SCS.

For yet another instance of this examples in this embodiment, M can be determined based on the SCS of the S-SSB, e.g., in the form of M=R*M′, wherein R=SCS_SSB/SCS_ref, and SCS_SSB is the SCS of the S-SSB, and SCS_ref is the reference SCS. For one sub-instance, SCS_ref=120 kHz. For another sub-instance, M′ can be fixed as 13. For yet another sub-instance, M′ can be (pre-)configured.

For yet another instance of this examples in this embodiment, M can be (pre-)configured.

For one instance of the examples in this embodiment, BW can be fixed. For one sub-instance, BW=11. For another sub-instance, BW is an integer larger than 11.

For another instance of this examples in this embodiment, BW can be fixed/pre-determined per the SCS of the S-SSB. For one sub-instance, BW=11 for 120 kHz SCS. For another sub-instance, BW=13 for 240 kHz SCS. For yet another sub-instance, BW=18 for 480 kHz SCS. For yet another sub-instance, BW=15 for 480 kHz SCS. For yet another sub-instance, BW=14 for 480 kHz SCS. For yet another sub-instance, BW=44 for 960 kHz SCS. For yet another sub-instance, BW=22 for 960 kHz SCS. For yet another sub-instance, BW=19 for 960 kHz SCS.

For yet another instance of this examples in this embodiment, BW can be (pre-)configured.

FIG. 10 illustrates a diagram of example S-SSB mapping 1000 according to embodiments of the present disclosure. For example, S-SSB mapping 1000 may be implemented by the UE 111 of FIG. 1. This example is for illustration only and other embodiments can be used without departing from the scope of the present disclosure.

In one embodiment, at least one S-SSB can be mapped into a number S of consecutive slots.

In a first example, with reference to FIG. 10, a number N_SSB of S-SSBs are mapped into S consecutive slots, wherein the first S-SSB within the N_SSB S-SSBs is mapped to a symbol with an offset O with respect to the first symbol in the S slots, every two neighboring S-SSBs have a gap of G symbols, and each S-SSB has M symbols as described in an example of this disclosure (e.g., FIG. 9). The S-SSB with relative index j_SSB is with a starting symbol s_SSB=O+j_SSB*(M+G), wherein 0≤j_SSB≤N_SSB−1, and the starting symbol is the relative starting symbol within the S slots.

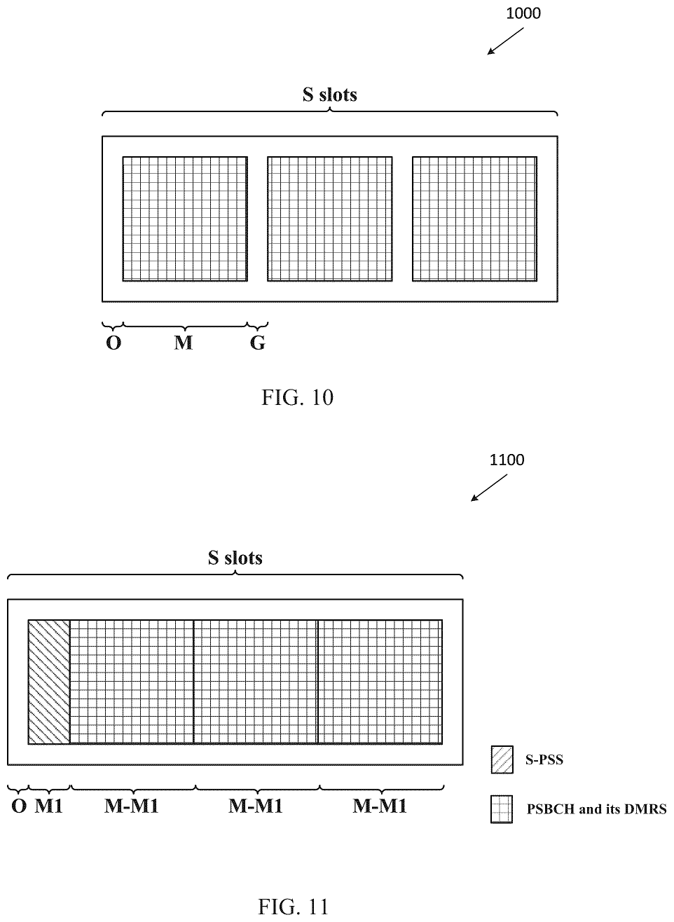

FIG. 11 illustrates a diagram of example S-SSB mapping 1100 according to embodiments of the present disclosure. For example, S-SSB mapping 1100 may be implemented by the UE 111 of FIG. 3. This example is for illustration only and other embodiments can be used without departing from the scope of the present disclosure.

In a second example, with reference to FIG. 11, a number N_SSB of S-SSBs are mapped into S consecutive slots, wherein the first S-SSB within the N_SSB S-SSBs is mapped to a symbol with an offset O with respect to the first symbol in the S slots, the first S-SSB includes M1 symbols for PSBCH (e.g., for AGC purpose) and the remaining M-M1 symbols as described in an example of this disclosure (e.g., FIG. 9), and the remaining S-SSB within the N_SSB S-SSBs does not includes the first M1 symbols for PSBCH and only includes the remaining M-M1 symbols as described in an example of this disclosure (e.g., FIG. 9). The S-SSB with relative index j_SSB is with a starting symbol s_SSB=O+M1+j_SSB*(M−M1) for i_SSB>0 or s_SSB=O for j_SSB=0, wherein 0≤j_SSB≤N_SSB−1 and the starting symbol is the relative starting symbol within the S slots.

For one instance of the examples in this embodiment, O can be fixed as 0, e.g., the first symbol of the first S-SSB is aligned with the first symbol of the first slot in the S slots.

For another instance of the examples in this embodiment, O can be (pre-)configured.

For one instance of the examples in this embodiment, G can be fixed as 0, e.g., no gap between neighboring S-SSBs.

For another instance of the examples in this embodiment, G can be (pre-)configured.

For one instance of the examples in this embodiment, S can be fixed. For one sub-instance, S=1. For another sub-instance, S=2.

For another instance of the examples in this embodiment, S can be fixed/pre-determined per the SCS of the S-SSB. For one sub-instance, S=1 for 120 kHz SCS. For another sub-instance, S=2 for 240 kHz SCS. For yet another sub-instance, S=4 for 480 kHz SCS. For yet another sub-instance, S=8 for 960 kHz SCS.

For yet another instance of this examples in this embodiment, S can be determined based on the SCS of the S-SSB, e.g., in the form of S=R*S′, wherein R=SCS_SSB/SCS_ref, and SCS_SSB is the SCS of the S-SSB, and SCS_ref is the reference SCS. For one sub-instance, SCS_ref=120 kHz. For another sub-instance, S′ can be fixed as 1. For yet another sub-instance, S′ can be (pre-)configured.

For yet another instance of the examples in this embodiment, S can be (pre-)configured.

For one instance of the examples in this embodiment, N_SSB can be fixed, e.g., N_SSB=1. For another sub-instance, N_SSB=2.

For another instance of the examples in this embodiment, N_SSB can be fixed/pre-determined per the SCS of the S-SSB. For one sub-instance, N_SSB=1 for 120 kHz SCS. For another sub-instance, N_SSB=2 for 240 kHz SCS. For yet another sub-instance, N_SSB=4 for 480 kHz SCS. For yet another sub-instance, N_SSB=8 for 960 kHz SCS.

For yet another instance of this examples in this embodiment, N_SSB can be determined based on the SCS of the S-SSB, e.g., in the form of N_SSB=R*N_SSB′, wherein R=SCS_SSB/SCS_ref, and SCS_SSB is the SCS of the S-SSB, and SCS_ref is the reference SCS. For one sub-instance, SCS_ref=120 kHz. For another sub-instance, N_SSB′ can be fixed as 1. For yet another sub-instance, N_SSB′ can be (pre-)configured.

For yet another instance of the examples in this embodiment, N_SSB can be (pre-)configured.

For yet another instance of the examples in this embodiment, N_SSB=S.

In one embodiment, the time domain pattern for S-SSB can be determined based on N_SSB.

For one example, a UE determines indexes of slot groups that include S-SSB as N_{offset}^{S-SSB}+(Nᵢₙₜₑᵣᵥₐₗ^{S-SSB}+1). └i_{S-SSB}/N_{SSB}┘, wherein a slot group is with S consecutive slots and includes N_{SSB} S-SSBs, and:
i_{S-SSB} is a S-SS/PSBCH block index within the number of S-SS/PSBCH blocks in the period, with 0≤i_{S-SSB}≤N_{period}^{S-SSB}−1.
N_{offset}^{S-SSB} is a slot group offset from a start of the period to the first slot including S-SS/PSBCH block, provided by a higher layer parameter (e.g., sl-TimeOffsetSSB).
Nᵢₙₜₑᵣᵥₐₗ^{S-SSB} is a slot group interval between S-SS/PSBCH blocks, provided by a higher layer parameter (e.g., sl-TimeInterval).

For another example, if N_SSB=S, then a UE determines indexes of slots that include S-SSB as N_{offset}^{S-SSB}+(Nᵢₙₜₑᵣᵥₐₗ^{S-SSB}+1)·└i_{S-SSB}/N_{SSB}┘+mod(i_{S-SSB},N_{SSB}), wherein
i_{S-SSB} is a S-SS/PSBCH block index within the number of S-SS/PSBCH blocks in the period, with 0≤i_{S-SSB}≤N_{period}^{S-SSB}−1.
N_{offset}^{S-SSB} is a slot offset from a start of the period to the first slot including S-SS/PSBCH block, provided by a higher layer parameter (e.g., sl-TimeOffsetSSB).
Nᵢₙₜₑᵣᵥₐₗ^{S-SSB} is a slot interval between S-SS/PSBCH blocks, provided by a higher layer parameter (e.g., sl-TimeInterval).

In one embodiment, the sidelink resource pool can be determined based on S.

For one example, the slots in a frame or a period can be grouped into a set of non-overlapping and consecutive slot groups, wherein each slot group includes S consecutive slots, and the first slot group starts from the beginning of a frame or a period.

For another example, the slot groups including S-SSB(s) are not included for sidelink resource pool.

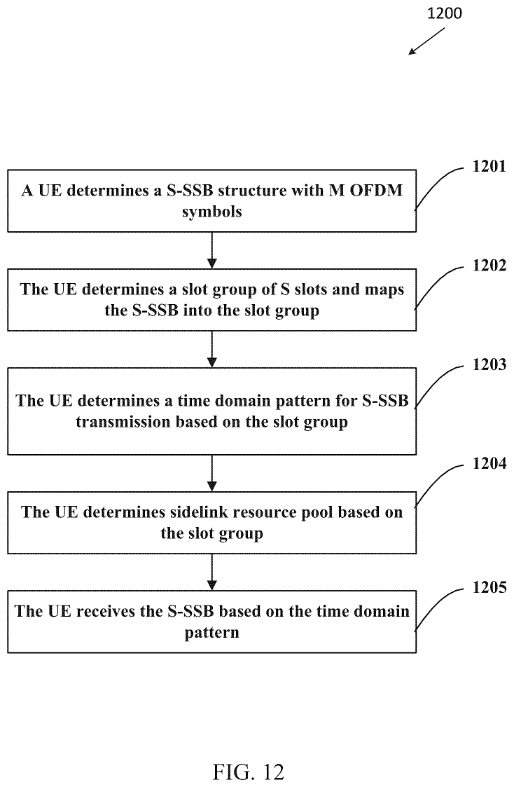

FIG. 12 illustrates a flowchart of an example UE procedure 1200 for determining the sidelink resource pool according to embodiments of the present disclosure. For example, procedure 1200 for determining the sidelink resource pool can be performed by the UE 111A of FIG. 1. This example is for illustration only and other embodiments can be used without departing from the scope of the present disclosure.

The procedure begins in 1201, a UE determines a S-SSB structure with M OFDM symbols. In 1202, the UE determines a slot group of S slots and maps the S-SSB into the slot group. In 1203, the UE determines a time domain pattern for S-SSB transmission based on the slot group. In 1204, the UE determines sidelink resource pool based on the slot group. In 1205, the UE receives the S-SSB based on the time domain pattern.

In one embodiment, with reference to FIG. 12, an example UE procedure for receiving S-SSB and determining the sidelink resource pool is shown.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine a number M of consecutive orthogonal frequency division multiplexing (OFDM) symbols for a sidelink synchronization signals and physical sidelink broadcast channel (S-SS/PSBCH) block;
determine a slot group of S consecutive slots including a number N_{SSB} of S-SS/PSBCH blocks; and
determine a time domain pattern for a number N_{period}^{S-SSB} of S-SS/PSBCH blocks within a period; and
a transceiver operably coupled to the processor, the transceiver configured to receive the S-SS/PSBCH block based on the time domain pattern.

2. The UE of claim 1, wherein the number M is (i) a fixed integer or (ii) based on a sub-carrier spacing (SCS) of the S-SS/PSBCH block.

3. The UE of claim 1, wherein S is based on (i) a higher layer parameter or (ii) a sub-carrier spacing (SCS) of the S-SS/PSBCH block and wherein:
S=1 when the SCS is 120 kilohertz (kHz),
S=2 when the SCS is 240 kHz,
S=4 when the SCS is 480 kHz, or
S=8 when the SCS is 480 kHz.

4. The UE of claim 1, wherein N_{SSB} is a fixed integer or same as S.

5. The UE of claim 1, wherein:
the time domain pattern for the number N_{period}^{S-SSB} of S-SS/PSBCH blocks is determined based on indexes of slot groups that include the number N_{period}^{S-SSB} of S-SS/PSBCH blocks;
the indexes are given by N_{offset}^{S-SSB}+(Nᵢₙₜₑᵣᵥₐₗ^{S-SSB}+1)·└i_{S_SSB}/N_{SSB}┘;
i_{S-SSB} is a S-SS/PSBCH block index within the number N_{period}^{S-SSB} period of S-SS/PSBCH blocks in the period, with 0≤i_{S-SSB}≤N_{period}^{S-SSB}−1;
N_{period}^{S-SSB} is a slot group offset from a start of the period to a first slot group including a S-SS/PSBCH block;
the slot group offset is provided by a first higher layer parameter;
Nᵢₙₜₑᵣᵥₐₗ^{S-SSB} is a slot group interval between slot groups including the number N_{period}^{S-SB} of S-SS/PSBCH blocks; and
the slot group interval is provided a second higher layer parameter.

6. The UE of claim 1, wherein the processor is further configured to:
determine first M₁ consecutive OFDM symbols within the M consecutive OFDM symbols, wherein each of the first M₁ consecutive OFDM symbols is mapped for a PSBCH in the S-SS/PSBCH block; and
determine last M₄ consecutive OFDM symbols within the M consecutive OFDM symbols, wherein each of the last M₄ consecutive OFDM symbols is mapped for the PSBCH.

7. The UE of claim 6, wherein:
the processor is further configured to determine M₂ consecutive OFDM symbols after the first M₁ consecutive OFDM symbols within the M consecutive OFDM symbols, and
each of the M₂ consecutive OFDM symbols is mapped for (1) a sidelink primary synchronization signal (S-PSS) or (2) the S-PSS that is frequency division multiplexed (FDMed) with the PSBCH.

8. The UE of claim 6, wherein:
the processor is further configured to determine M₃ consecutive OFDM symbols before the last M₄ consecutive OFDM symbols within the M consecutive OFDM symbols, and
each of the M₃ consecutive OFDM symbols is mapped for (1) a sidelink secondary synchronization signal (S-SSS) or (2) the S-SSS that is frequency division multiplexed (FDMed) with the PSBCH.

9. The UE of claim 1, wherein:
the processor is further configured to determine a sidelink resource pool, and
the slot group including the number N_{SSB} of S-SS/PSBCH blocks is not determined to be within the sidelink resource pool.

10. The UE of claim 1, wherein:
the processor is further configured to determine a number of resource blocks (RBs) for the S-SS/PSBCH block, and
the number of RBs is (i) a fixed integer or (ii) based on a sub-carrier spacing (SCS) of the S-SS/PSBCH block.

11. A method performed by a user equipment (UE) in a wireless communication system, the method comprising:
determining a number M of consecutive orthogonal frequency division multiplexing (OFDM) symbols for a sidelink synchronization signals and physical sidelink broadcast channel (S-SS/PSBCH) block;
determining a slot group of S consecutive slots including a number N_{SSB} of S-SS/PSBCH blocks;
determining a time domain pattern for a number N_{period}^{S-SSB} of S-SS/PSBCH blocks within a period; and
receiving the S-SS/PSBCH block based on the time domain pattern.

12. The method of claim 11, wherein the number M is (i) a fixed integer or (ii) based on a sub-carrier spacing (SCS) of the S-SS/PSBCH block.

13. The method of claim 11, wherein S is based on (i) a higher layer parameter; or (ii) a sub-carrier spacing (SCS) of the S-SS/PSBCH block and wherein:
S=1 when the SCS is 120 kilohertz (kHz),
S=2 when the SCS is 240 kHz,
S=4 when the SCS is 480 kHz, or
S=8 when the SCS is 480 kHz.

14. The method of claim 11, wherein N_{SSB} is a fixed integer or same as S.

15. The method of claim 11, wherein:
the time domain pattern for the number N_{period}^{S-SSB} of S-SS/PSBCH blocks is determined based on indexes of slot groups that include the number N_{period}^{S-SSB} of S-SS/PSBCH blocks;
the indexes are given by N_{offset}^{S-SSB}+(Nᵢₙₜₑᵣᵥₐₗ^{S-SSB}+1)·└i_{S_SSB}/N_{SSB}┘;
i_{S-SSB} is a S-SS/PSBCH block index within the number N_{period}^{S-SSB} period of S-SS/PSBCH blocks in the period, with 0≤i_{S-SSB}≤N_{period}^{S-SSB}−1;
N_{period}^{S-SSB} is a slot group offset from a start of the period to a first slot group including a S-SS/PSBCH block;
the slot group offset is provided by a first higher layer parameter;
Nᵢₙₜₑᵣᵥₐₗ^{S-SSB} is a slot group interval between slot groups including the number N_{period}^{S-SB} of S-SS/PSBCH blocks; and
the slot group interval is provided a second higher layer parameter.

16. The method of claim 11 further comprising:
determining first M₁ consecutive OFDM symbols within the M consecutive OFDM symbols, wherein each of the first M₁ consecutive OFDM symbols is mapped for a PSBCH in the S-SS/PSBCH block; and
determining last M₄ consecutive OFDM symbols within the M consecutive OFDM symbols, wherein each of the last M₄ consecutive OFDM symbols is mapped for the PSBCH.

17. The method of claim 16 further comprising:
determining M₂ consecutive OFDM symbols after the first M₁ consecutive OFDM symbols within the M consecutive OFDM symbols,
wherein each of the M₂ consecutive OFDM symbols is mapped for (1) a sidelink primary synchronization signal (S-PSS) or (2) the S-PSS that is frequency division multiplexed (FDMed) with the PSBCH.

18. The method of claim 16 further comprising:
determining M₃ consecutive OFDM symbols before the last M₄ consecutive OFDM symbols within the M consecutive OFDM symbols,
wherein each of the M₃ consecutive OFDM symbols is mapped for (1) a sidelink secondary synchronization signal (S-SSS) or (2) the S-SSS that is frequency division multiplexed (FDMed) with the PSBCH.

19. The method of claim 11 further comprising:
determining a sidelink resource pool,
wherein the slot group including the number N_{SSB} of S-SS/PSBCH blocks is not determined to be within the sidelink resource pool.

20. The method of claim 11 further comprising:
determining a number of resource blocks (RBs) for the S-SS/PSBCH block,
wherein the number of RBs is (i) a fixed integer or (ii) based on a sub-carrier spacing (SCS) of the S-SS/PSBCH block.
